(19) United States
(12) Patent Application Publication
(10) Pub. No.: US 2016/0221019 A1
(43) Pub. Date: Aug. 4, 2016

(54) LIQUID DISPENSER

(71) Applicants: Wade M. Bassett, Albia, IA (US); Lisa L. Bassett, Albia, IA (US)

(72) Inventors: Wade M. Bassett, Albia, IA (US); Lisa L. Bassett, Albia, IA (US)

(21) Appl. No.: 14/612,864

(22) Filed: Feb. 3, 2015

(51) Int. Cl. B05B 15/06; A47K 5/00; B05B 11/00

(52) U.S. Cl. CPC B05B 15/061; B05B 11/3042; A47K 5/00

(57) ABSTRACT

A liquid dispenser includes a body having an inner cavity for containing liquid, and an opening providing access to the inner cavity. The liquid dispenser further includes a pump removably fitted with the aperture with a dip extension extending downwardly into the inner cavity, the dip extension having an inlet. The inlet of the dip extension is positioned within the inner cavity at a junction of a front side of the body and a bottom side of the body to thereby access fluid within the inner cavity when the fluid is nearly depleted from the inner cavity.

### FIELD OF THE INVENTION

The present invention relates to the dispensement of liquids. More particularly, but not exclusively, the present invention relates to a device and method for dispensing liquids such as hand cleaning fluid in a vehicle or other unconventional use environments.

### BACKGROUND OF THE INVENTION

Liquid dispensers that incorporate push pumps are found in various places throughout the home, including in the kitchen and bathroom. These liquid dispensers can be used for dispensing soap, lotion, or other types of liquid. However, conventional liquid dispensers may be inconvenient to use in other environments including, for example, in boats, recreational vehicles (RVs), other vehicles, and other environments where liquid may need to be dispensed.

Moreover, the importance of hand cleaning fluids has grown due to heightened health and sanitation concerns including concerns regarding the spread of the Ebola virus as well as other disease. Thus, what is needed are devices which can be used for dispensing fluids which are well-suited for use in unconventional and non-traditional environments not typically associated with the use of liquid dispensers.

### SUMMARY OF THE INVENTION

Thus, it is a primary object, feature, or advantage of the present invention to improve upon the state of the art.

It is a further object, feature, or advantage of the present invention to provide a liquid dispenser that is configured to be used in unconventional locations such as, but not limited to, within vehicles.

It is a still further object, feature, or advantage of the present invention to provide a liquid dispenser which attaches to any smooth surface such as a window, windscreen, or any glass type surface, making the dispenser adaptable to various environments including, but not limited to the home environment, any type of motorized or non-motorized vehicle such as an automobile, boat, RV, camper, plane, train, bus, taxi, or other vehicle.

Another object, feature, or advantage is to provide a liquid dispenser which is configured to attach to a sun visor within a vehicle or door panel or other location.

Yet another object, feature, or advantage is to provide a liquid dispenser that is mounted to improve transportation safety by not having a conventional dispenser laying, rolling around, and difficult to locate.

A further object, feature, or advantage is to provide a mounted liquid dispenser then only requiring one hand to operate.

A still further object, feature, or advantage is to provide a liquid dispenser that is mounted to safely, conveniently, and clearly remind the user to use the dispensing system.

Yet another object, feature, or advantage is to provide a liquid dispenser which includes an offset opening to position the pump and dip extension to the lower part of the container.

A further object, feature, or advantage is to provide a liquid dispenser with an angled dip extension positioning it to the lower part of the container.

A still further object, feature, or advantage is to provide a liquid dispenser with an angled aperture to point a normal dip extension/pump towards the low point of the container.

Another object, feature, or advantage is to provide a liquid dispenser with a top of the liquid dispenser having a slope to thereby point the aperture, pump, and dip extension towards the low point of the container.

Yet another object, feature, or advantage of the present invention is to provide a liquid dispenser which has a flexible dip extension allowing gravity to place the dip extension at the low point of the container.

A still further object, feature, or advantage of the present invention is to provide for automated or handsfree dispensing.

These and/or other objects, features or advantages of the present invention will become apparent from the specification and claims. No single embodiment need provide each and every object, feature, or advantage as it is contemplated that different embodiments may have different objects, features, or advantages. The present invention is not to be limited by these objects, features, or advantages.

According to one aspect, a liquid dispenser includes a body having an inner cavity for containing liquid, and an opening providing access to the inner cavity. The liquid dispenser further includes a pump removably fitted with the aperture with a dip extension extending downwardly into the inner cavity, the dip extension having an inlet. The inlet of the dip extension is positioned within the inner cavity at a junction of a front side of the body and a bottom side of the body to thereby access fluid within the inner cavity when the fluid is nearly depleted from the inner cavity. At least one mount may be connected to the body for releasably attaching the body to a surface. The at least one mount can include one or more suction cups or clips.

According to another aspect, the opening may be positioned such that it is offset from a top center position on the dispenser body. Thus, the dip extension can provide better access to liquid stored in the front and bottom of the cavity formed by the dispenser body.

According to another aspect, the opening may be positioned in a portion of the dispenser body that protrudes outwardly from the top and/or front sides of the dispenser body. Thus, the dip extension can provide better access to liquid stored in the front and bottom of the cavity formed by the dispenser body.

According to another aspect, the dip extension may be bent or sloped such that the dip extension can provide better access to liquid stored in the front and bottom of the cavity formed by the dispenser body.

According to another aspect, the dip extension may be flexible such that the dip extension can be positioned to provide better access to liquid stored in the front and bottom of the cavity formed by the dispenser body.

### BRIEF DESCRIPTION OF THE DRAWINGS

FIG. 1 is a perspective view of a push pump used in one embodiment of a liquid dispenser of the present invention.

FIG. 2 is a perspective view of a push pump used in one embodiment of a liquid dispenser of the present invention.

FIG. 3 is a perspective view of a push pump used in one embodiment of a liquid dispenser of the present invention.

FIGS. 4A-C illustrate one embodiment of a liquid dispenser with suction cup adapter and an offset opening according to one embodiment of the present invention.

FIGS. 5A-C illustrate one embodiment of a liquid dispenser with suction cup adapter and bent dip extension according to one embodiment of the present invention.

FIGS. 6A-C illustrate one embodiment of a liquid dispenser with suction cup adapter and flexible dip extension according to one embodiment of the present invention.

FIGS. 7A-C illustrate one embodiment of a liquid dispenser with suction cup adapter and a protruding surface according to one embodiment of the present invention.

FIGS. 8A-C illustrate one embodiment of a liquid dispenser with suction cup adapter and an angled top according to one embodiment of the present invention.

FIGS. 9A-C illustrate one embodiment of a liquid dispenser with suction cup adapter and an angled aperture according to one embodiment of the present invention.

FIG. 10 is a side view of one embodiment of a liquid dispenser attached to an automotive windshield according to the present invention.

FIGS. 11A-C illustrate one embodiment of a liquid dispenser with visor clip adapter and an offset opening according to one embodiment of the present invention.

FIGS. 12A-C illustrate one embodiment of a liquid dispenser with visor clip adapter and bent dip extension according to one embodiment of the present invention.

FIGS. 13A-C illustrate one embodiment of a liquid dispenser with visor clip adapter and flexible dip extension according to one embodiment of the present invention.

FIGS. 14A-C illustrate one embodiment of a liquid dispenser with visor clip adapter and a protruding surface according to one embodiment of the present invention.

FIGS. 15A-C illustrate one embodiment of a liquid dispenser with visor clip adapter and an angled top according to one embodiment of the present invention.

FIGS. 16A-C illustrate one embodiment of a liquid dispenser with visor clip adapter and an angled aperture according to one embodiment of the present invention.

FIG. 17 is a side view of one embodiment of a liquid dispenser attached to an automotive sun visor according to the present invention.

FIG. 18 is a perspective view of another embodiment of a push pump.

FIG. 19 illustrates a liquid dispenser using the push pump shown in FIG. 18.

FIG. 20 illustrates another embodiment of a push pump.

FIG. 21 illustrates an embodiment where the pump is located at a bottom of the liquid dispenser.

FIG. 22 illustrates another embodiment of a liquid dispenser where the push pump would be located at the bottom of the liquid dispenser and a push pin is in an extended position.

FIG. 23 illustrates the liquid dispenser of FIG. 21 except that the push pin is in a retracted position.

FIG. 24 illustrates an embodiment where an electric pump is used instead of a push pump.

### DETAILED DESCRIPTION OF THE PREFERRED EMBODIMENT

The present invention provides for a liquid dispenser that can be removably attached to an automobile windshield interior or other surface using one or more suction cups. The liquid dispenser can also be attached to a sun visor or other location using a clip. Embodiments of the invention include all technically compatible combinations of the various features disclosed herein.

The present invention is may be used in various environments. The environments shown and described are not to be limiting, but merely representative of the environments in which the liquid dispenser of the present invention is used. It should be appreciated that different types of liquid may be used in different environments. The present invention is in no way limited to the particular type of liquid used. The liquid can be, without limitation, soap, lotion, shampoo, gel, foam, hair care liquid, a cleaning liquid, or any other type of liquid. However, the liquid dispenser is especially well-suited for mounting to a the inward slope of a front windshield, windshield, window, sun visor or other locations, especially in vehicles, and for containing disinfecting or sanitizing liquids such as those used to minimize spread of diseases such as Ebola, influenza, the common cold, and other diseases.

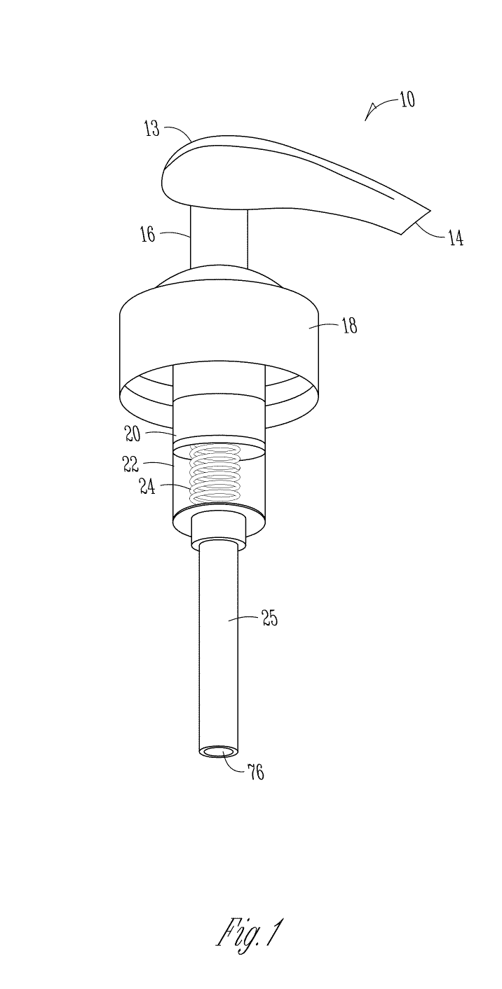

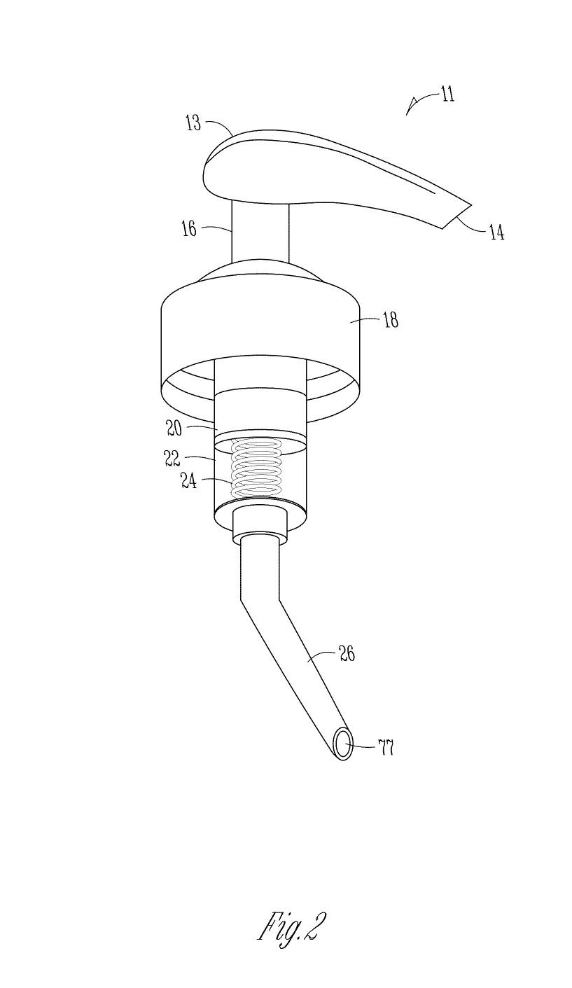

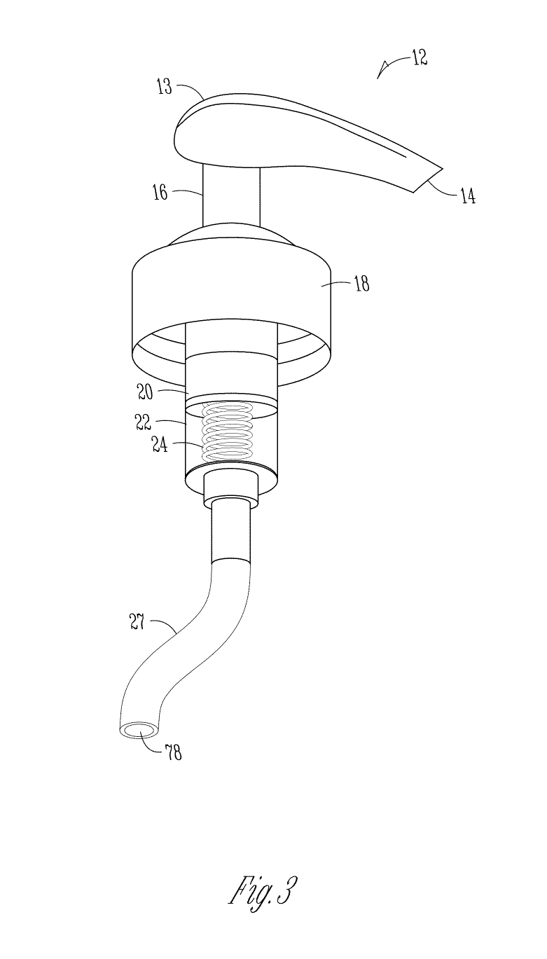

FIGS. 1, 2, and 3 illustrate various embodiments of a push pump. In FIG. 1, the push pump assembly 10 includes a neck 16. The neck 16 can extend above the dispenser body. The push pump assembly 10 fits within the dispenser body. One method of attaching the push pump assembly 10 to the dispenser body is by securing it with a threaded cap member 18. The push pump assembly 10 shown has an inside spring 24 and a piston pump area 22 in which a piston pump 20 is positioned. A straight dip tube or pump extension or dip extension 25 for the dispenser body is shown and an outlet 14 is shown on the pump head 13. Liquid, such as sanitizing liquid, is drawn through the inlet 76 and is secreted through the outlet 14. In contrast to FIG. 1, FIG. 2 illustrates a push pump assembly 11 which fits within the dispenser body. One method of attaching the push pump assembly 11 to the dispenser body is by securing it with a threaded cap member 18. The push pump assembly 11 shown has an inside spring 24 and a piston pump area 22. Push pump assembly 11 utilizes a bent or sloped dip extension 26 for the dispenser body. An outlet 14 is shown on the pump head 13. Liquid is drawn through the inlet 77 and is secreted through the outlet 14. FIG. 3 illustrates a push pump assembly 12 which fits within the dispenser body similar to FIGS. 1 and 2. The push pump assembly 12 uses a flexible dip extension 27 which allows gravity to place the dip extension 27 at the low point of the container.

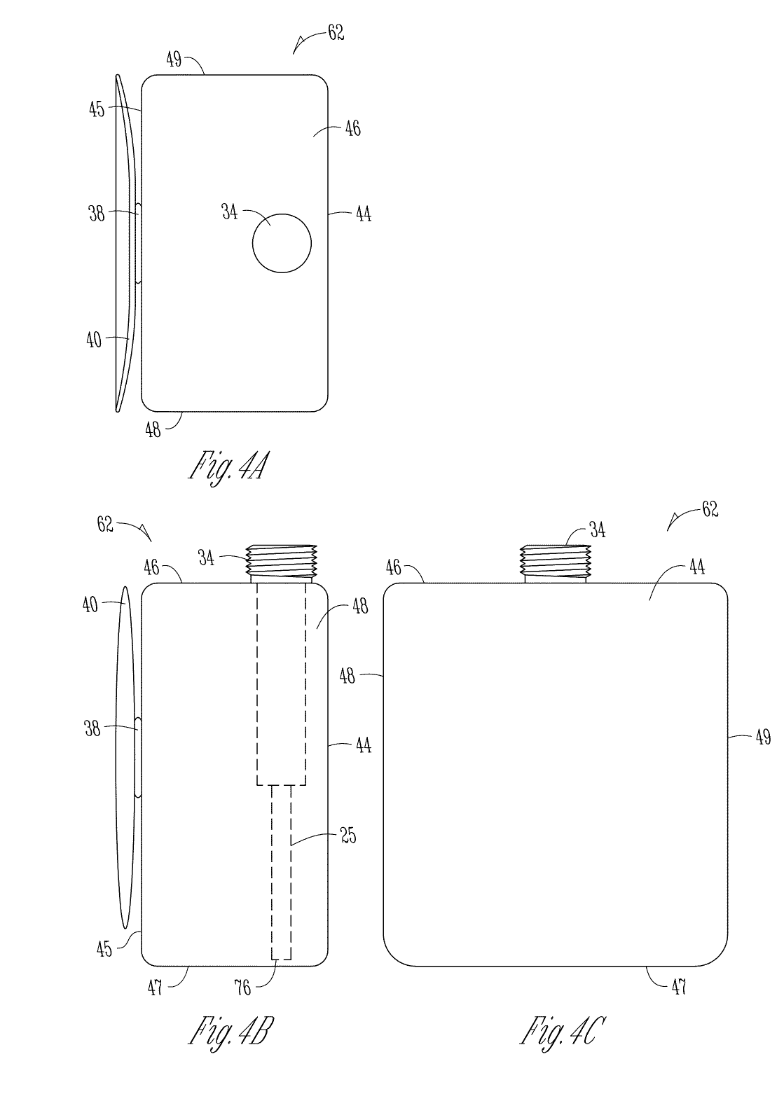

FIGS. 4A-C illustrate a dispenser body 62 which forms an inner cavity for containing liquid. The dispenser body 62 has a front side 44 and a rear side 45 which are generally wider than the left side 48 and the right side 49 in the embodiment shown. The front side 44 and the rear side 45 are generally parallel to each other. The left side 48 and the right side 49 are generally parallel to each other. A top side 46 and a bottom side 47 are generally parallel to each other. Thus sides 44, 45, 46, 47, 48, and 49 form the dispenser body 62. The top side 46 has a mounting opening 34 for the pump assembly which is offset from the center towards the front side 44. The opening 34 remains centered between the left and right sides 48 and 49. A removable pump assembly (such as the pump assembly 10 from FIG. 1) may be connected at the opening 34. A mounting attachment 38 allows for a suction cup 40 to be easily attached to and removed from the dispenser body 62. The offset opening 34 positions the dip extension 25 and thus the inlet 76 of the pump assembly 10 towards the lower part of the dispenser body 62 where the front side 44 and the bottom side 47 meet. In other words, the inlet 76 of the dip extension 25 is positioned within the inner cavity at or near a junction of the front side 44 of the body and a bottom side 47 of the body to thereby access fluid within the inner cavity when the fluid is nearly depleted from the inner cavity. This arrangement provides for maximizing the amount of product the liquid dispenser can deliver between refills when attached to a vehicle windshield, window, or visor and more fully use liquid within the dispenser body 62 when the liquid dispenser is attached in the vehicle.

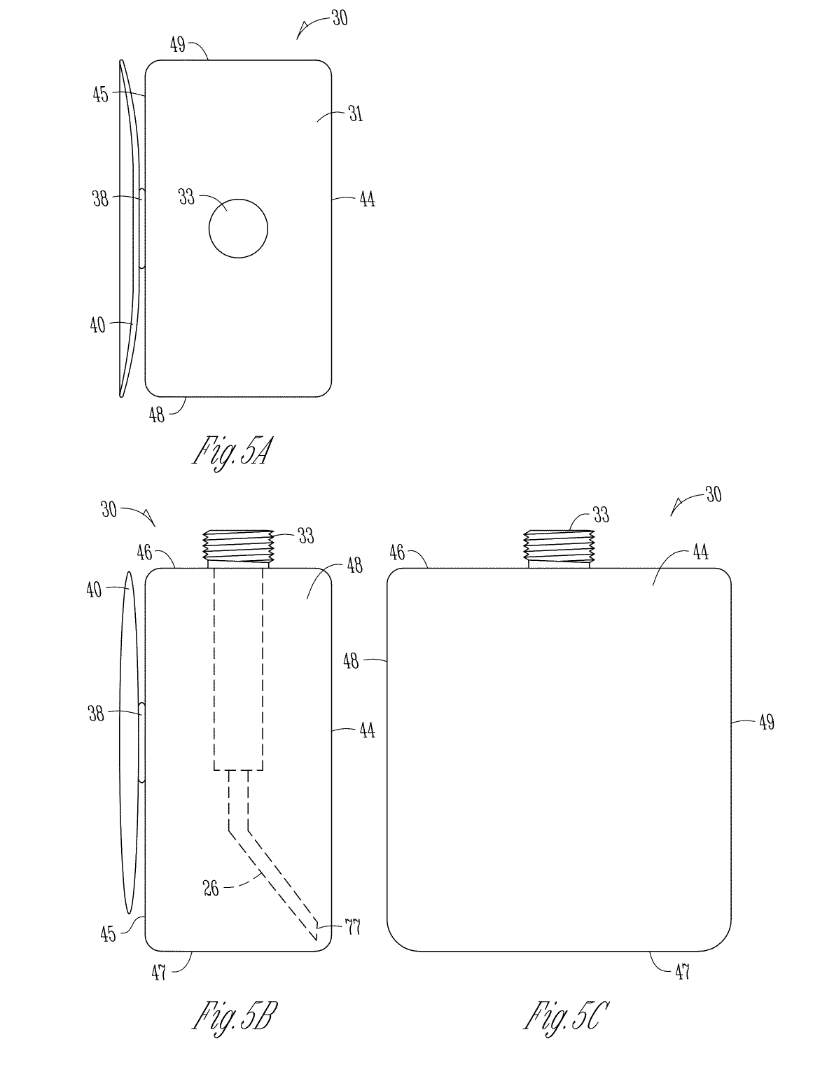

FIGS. 5A-C illustrate a dispenser body 30 which forms an inner cavity for containing liquid. The dispenser body 30 has a front side 44 and a rear side 45 which are generally wider than a left side 48 and a right side 49. The front side 44 and the rear side 45 are generally parallel to each other. The left side 48 and the right side 49 are generally parallel to each other. A top side 46 and a bottom side 47 are generally parallel to each other. Thus the sides 44, 45, 46, 47, 48, and 49 are joined together to form the dispenser body 30. The top side 31 has a mounting opening 33 for a pump assembly which is centered on the top side along a major and a minor axis. A removable pump assembly (such as pump assembly 11 from FIG. 2) may be attached at the opening 33. A mounting attachment 38 allows for a suction cup 40 to be easily attached to and removed from the dispenser body 30. The centered opening 33 positions the dip extension 26 such that its inlet 77 is towards the front lower part of dispenser body 30 where the front side 44 and the bottom side 47 meet. In other words, the inlet 77 of the dip extension 26 is positioned within the inner cavity at a junction of the front side 44 of the body and a bottom side 47 of the body to thereby access fluid within the inner cavity when the fluid is nearly depleted from the inner cavity. This provides for maximizing the amount of product the liquid dispenser can deliver between refills when attached to a vehicle windshield, window, or other location.

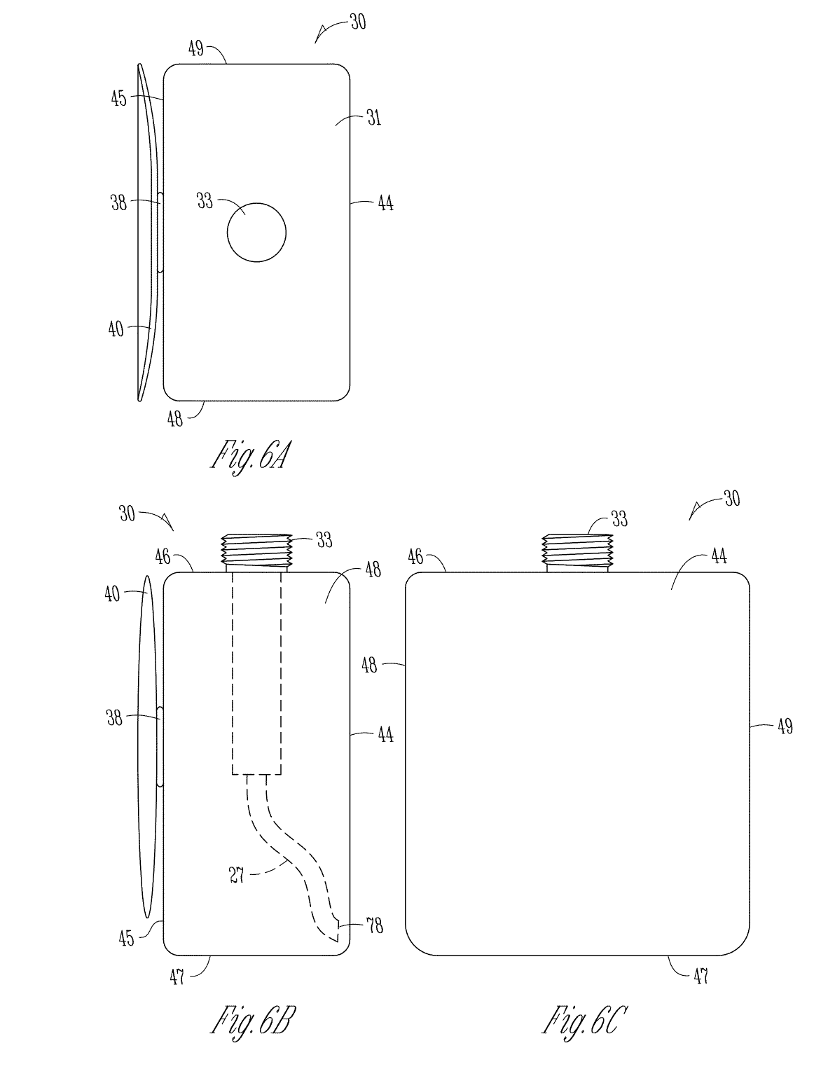

FIGS. 6A-C illustrate a dispenser body 30 which forms an inner cavity for containing liquid. The dispenser body 30 has a front side 44 and a rear side 45 which are generally wider than the left side 48 and the right side 49. The front side 44 and the rear side 45 are generally parallel to each other. The left side 48 and the right side 49 are generally parallel to each other. A top side 46 and a bottom side 47 are generally parallel to each other. The top side 31 has a mounting opening 33 for the pump assembly 12 which is centered on the top side 31 along both the major axis and the minor axis. A removable pump assembly (such as removable pump assembly 12 shown in FIG. 3) is attached into the opening 33. A mounting attachment 38 allows for a suction cup 40 to be easily attached and removed to the dispenser body 30. The centered opening 33 positions a dip extension 27 of the pump assembly towards the front lower part of dispenser body 30 where the front side 44 and the bottom side 47 meet to maximize the amount of product the liquid dispenser can deliver between refills when attached to a vehicle windshield or window or other location. The dip extension 27 is flexible allowing the inlet 78 to follow the edge created by the front side 44 and the bottom side 47. In other words, the inlet 78 of the dip extension 27 may be positioned within the inner cavity at a junction of the front side 44 of the body and a bottom side 47 of the body to thereby access fluid within the inner cavity when the fluid is nearly depleted from the inner cavity.

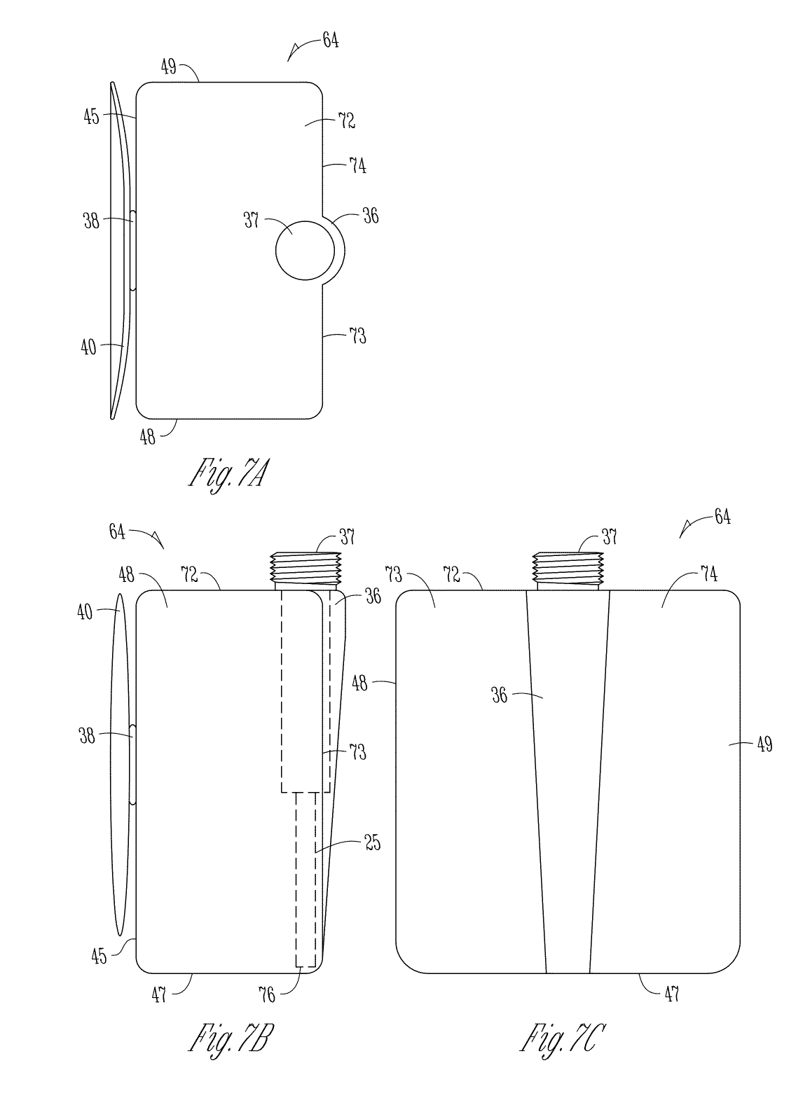

FIGS. 7A-C illustrate a dispenser body 64 which forms an inner cavity for containing liquid. The dispenser body 64 has a front side with portions 73, 74, on opposite ends of a protruding portion 36. The left side 48 and the right side 49 are generally parallel to each other. A top side 72 and a bottom side 47 are generally parallel to each other. The corners at the junctions of the sides are generally rounded. The top side has a mounting opening 37 for a pump assembly. The opening 37 is offset towards the protruding portion 36. The opening 37 remains centered between left and right sides 48 and 49. A removable pump assembly (such as removable pump assembly 10 from FIG. 1) may be attached into the opening 37. A mounting attachment 38 allows for a suction cup 40 to be easily attached and removed to the dispenser body 64. The location of the opening 37 positions the dip extension 25 of the pump assembly 10 and its inlet 76 towards the lower part of the dispenser body 64 to maximize the amount of product liquid dispenser can deliver between refills such as when the liquid dispenser is attached to a vehicle windshield or window.

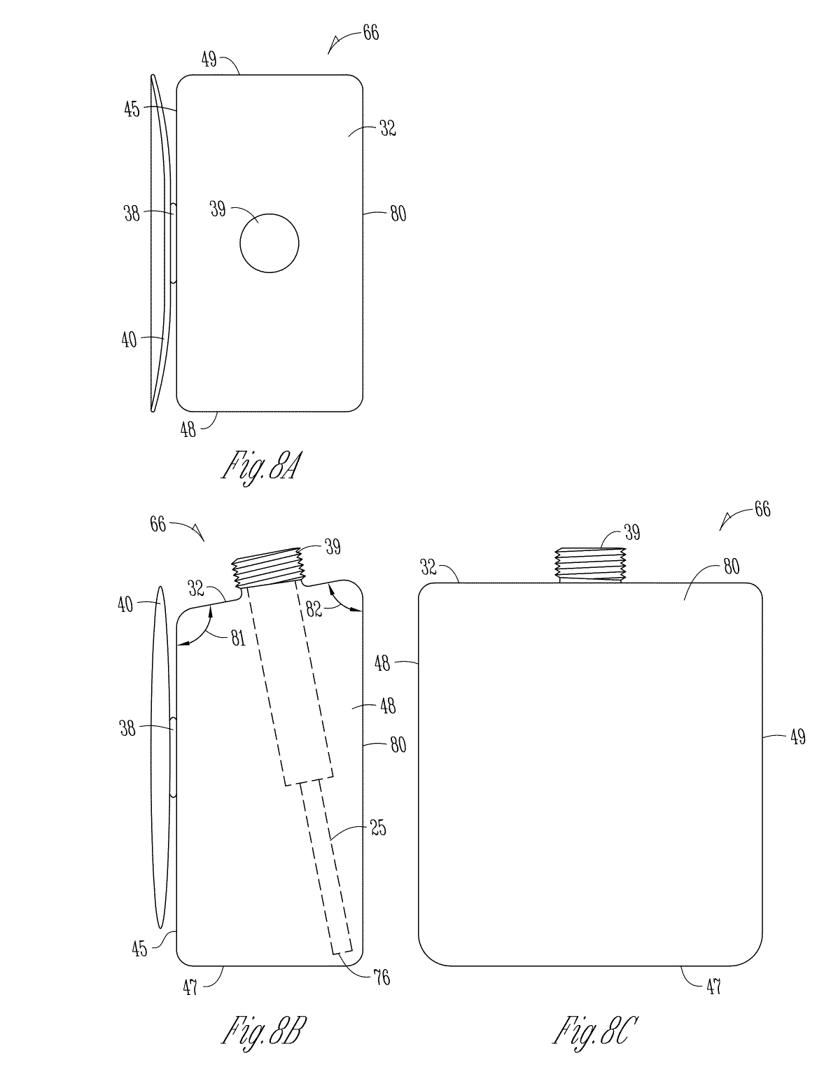

FIGS. 8A-C illustrate a dispenser body 66 which forms an inner cavity for containing liquid. The dispenser body 66 has a front side 80 and a rear side 45, a left side 48 and right side 49. The front side 80 and the rear side 45 are generally parallel to each other. The left side 48 and the right side 49 are generally parallel to each other. The top side 32 has a mounting opening 39 for the pump assembly 10 which is centered front to rear and left to right. The top side 32 is not parallel to the bottom side 47. The angle 81 formed by the surface of the top side 32 and the surface of the rear side 45 is obtuse. The angle 82 formed by the surface of the front side 80 and the surface of the top side 32 is acute. A mounting attachment 38 allows for a suction cup 40 to be easily attached and removed to the dispenser body 66. The angled opening 39 positions the inlet 76 of the dip extension 25 of the pump assembly towards the lower part of the dispenser body 66 where the front side 80 and bottom side 47 converge to maximize the amount of product the liquid dispenser can deliver between refills when attached to a vehicle windshield or window.

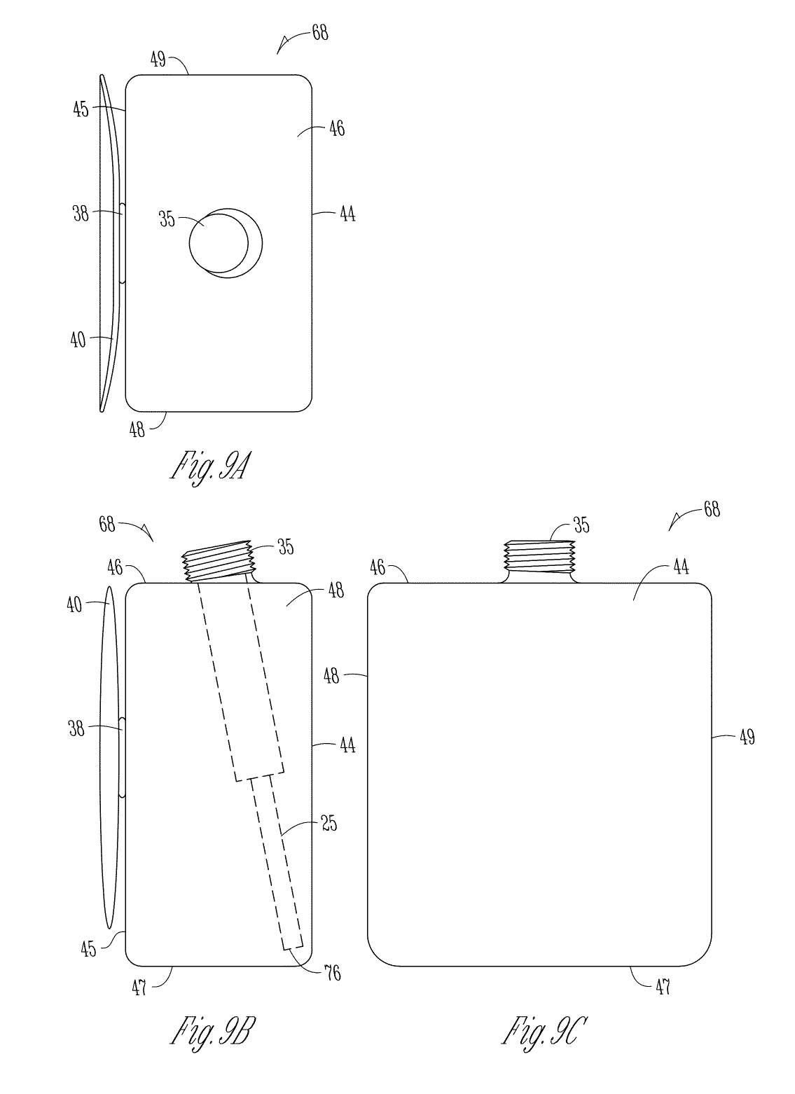

FIGS. 9A-C illustrate a dispenser body 68 which forms an inner cavity for containing liquid. The dispenser body 68 has a front side 44 and a rear side 45 which are generally wider than the left surface 48 and the right side 49. The front side 44 and the rear side 45 are generally parallel to each other. The left side 48 and the right side 49 are generally parallel to each other. A top side 46 and a bottom side 47 are generally parallel to each other and the corners are generally rounded. On the top side 46 is an angled mounting aperture 35. The mounting aperture 35 is centered between surfaces of the sides 44, 45, 48, and 49. A removable pump assembly is attached into the opening 35. A mounting attachment 38 allows for a suction cup 40 to be easily attached and removed to the dispenser body 68. Instead of a single suction cup, multiple suctions cups could be used or alternative mounting mechanisms may be used. The mounting aperture 35 positions the inlet 76 of the dip extension 25 of the pump assembly towards the lower part of the dispenser body 68 where surfaces of the front side 44 and the bottom side 47 converge or join to maximize the amount of product the liquid dispenser can deliver between refills when attached to a car windshield or window.

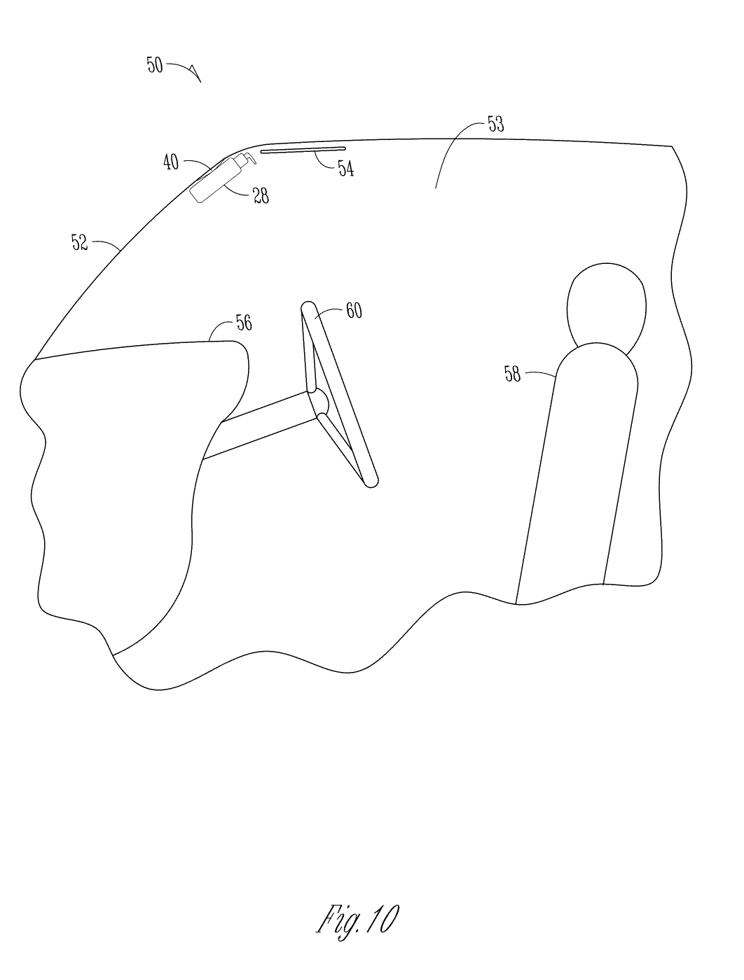

FIG. 10 illustrates the liquid dispenser is attached to a vehicle windshield. The vehicle cabin generally has a seat 58, a steering wheel 60 and a dash 56. The liquid dispenser 28 is attached to a windshield or windscreen 52 via a suction cup 40 within the vehicle cabin 50. The liquid dispenser 28 may also be attached to a window 53 of the vehicle. In either position, the dispenser is preferably positioned within a safe reaching distance of the driver and/or passenger. In this embodiment, the liquid dispenser may be particularly useful when used to dispense a sanitizing fluid or disinfecting fluid. Thus, a person could sanitize their hands and/or surfaces of the vehicle each time they entered or exited the vehicle. This may assist in stopping the spread of diseases.

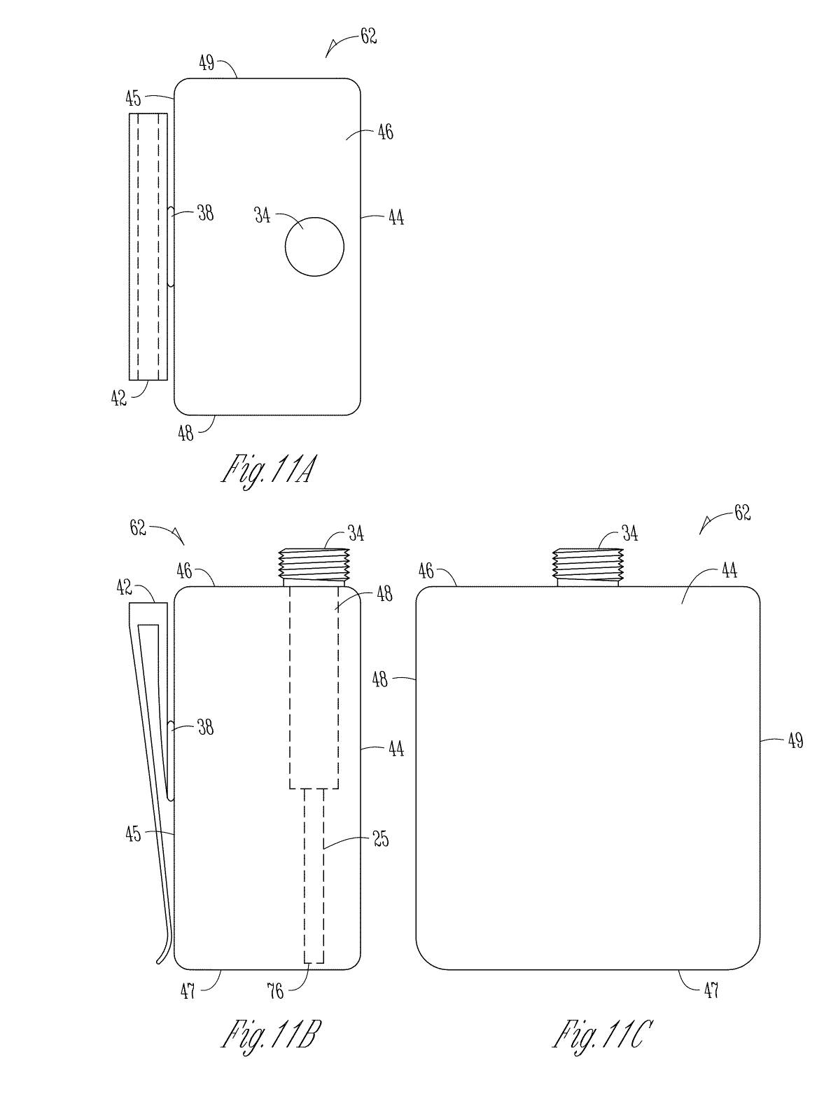

FIGS. 11A-C illustrate a dispenser body 62 which forms an inner cavity for containing liquid. The dispenser body 62 has a front side 44 and a rear side 45 which are generally wider than the left side 48 and the right side 49. The front side 44 and the rear side 45 are generally parallel to each other. The left side 48 and the right side 49 are generally parallel to each other. A top side 46 and a bottom side 47 are generally parallel to each other. The corners may be generally rounded. The top side 46 has a mounting opening 34 for a pump assembly which is offset from center towards the front side 44. The opening 34 remains centered between left and right sides 48 and 49. A removable pump assembly may be attached into the opening 34. A mounting attachment 38 allows for a clip 42 to be easily attached and removed to the dispenser body 62. The offset opening 34 positions the dip extension 25 and thus the inlet 76 towards the lower part of dispenser body 62 where the front side 44 and the bottom side 47 meet to maximize the amount of product the liquid dispenser can deliver between refills when attached to a vehicle sun visor or door panel or other location.

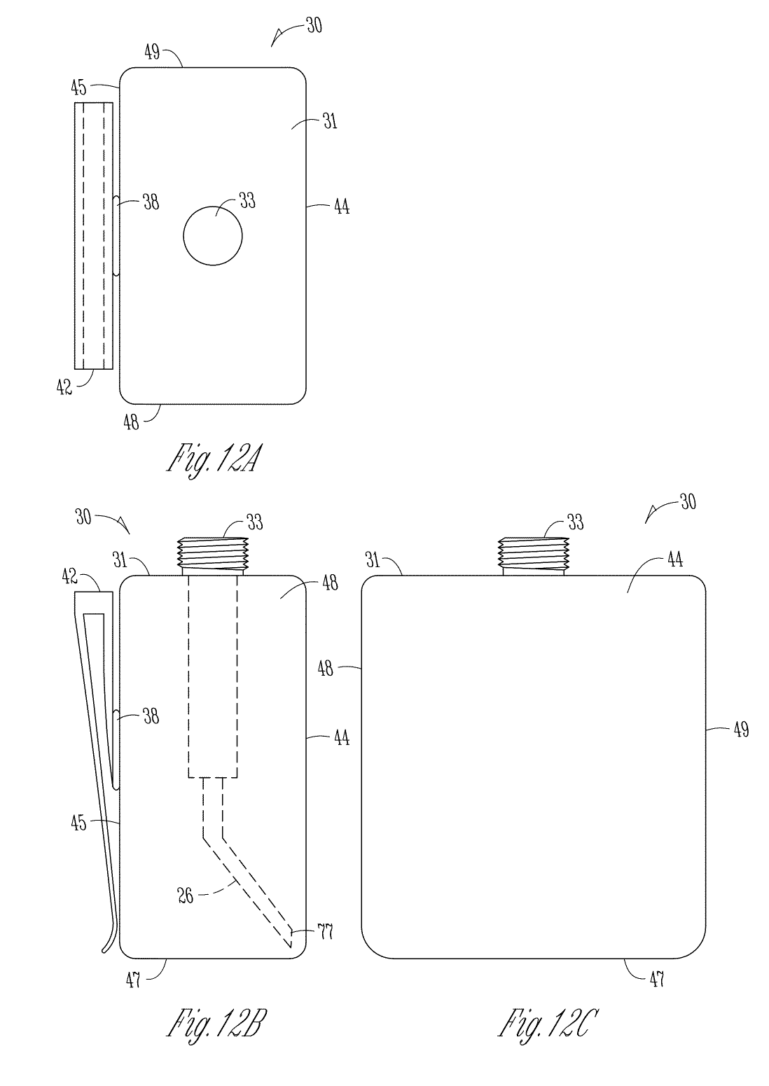

FIGS. 12A-C illustrate a dispenser body 30 which forms an inner cavity for containing liquid. The dispenser body 30 has a front side 44 and a rear side 45 which are generally wider than the left side 48 and the right side 49. The front side 44 and the rear side 45 are generally parallel to each other. The left side 48 and the right side 49 are generally parallel to each other. A top side 46 and a bottom side 47 are generally parallel to each other. The top side 31 has a mounting opening 33 for a pump assembly which is centered between sides 44, 45, 48, and 49. A removable pump assembly may be attached into the opening 33. A mounting attachment 38 allows for a clip 42 to be easily attached and removed to the dispenser body 30. The centered opening 33 positions the inlet 77 of the dip extension 26 towards the front lower part of the dispenser body 30 where the front side 44 and the bottom side 47 meet to maximize the amount of product the liquid dispenser can deliver between refills when attached to a car sun visor or door panel or other location.

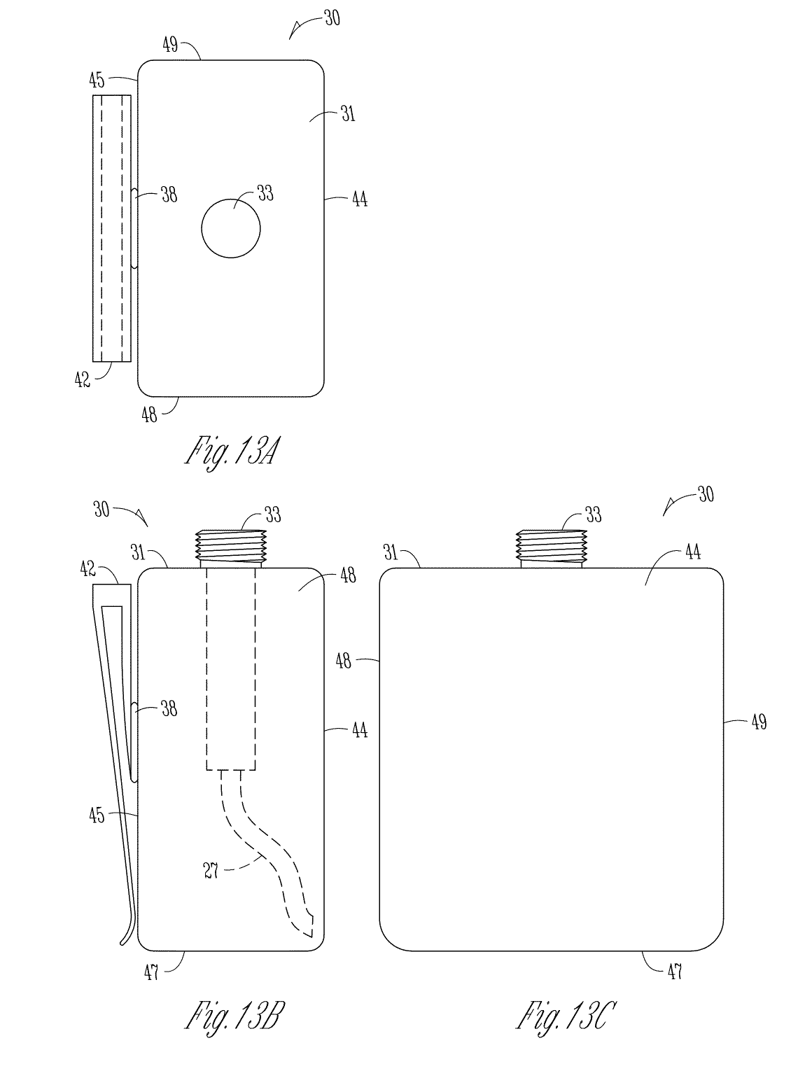

FIGS. 13A-C illustrate a dispenser body 30 which forms an inner cavity for containing liquid. The dispenser body 30 has a front side 44 and a rear side 45 which are generally wider than a left side 48 and a right side 49. The front side 44 and the rear side 45 are generally parallel to each other. The left side 48 and the right side 49 are generally parallel to each other. A top side 46 and a bottom side 47 are generally parallel to each other. The top side 31 has a mounting opening 33 for this pump assembly, the opening 33 centered between sides opposite pairs of sides 44, 45 and 48, 49. A removable pump assembly may be attached into the opening 33. A mounting attachment 38 allows for a clip 42 to be easily attached and removed to the dispenser body 30. The centered opening 33 positions the inlet 78 of the dip extension 27 towards the front lower part of the dispenser body 30 where the front side 44 and the bottom side 47 meet to maximize the amount of product the liquid dispenser can deliver between refills when attached to a vehicle sun visor or door panel or other location. The dip extension 27 is flexible thereby allowing inlet 78 to follow the edge created by front side 44 and bottom side 47.

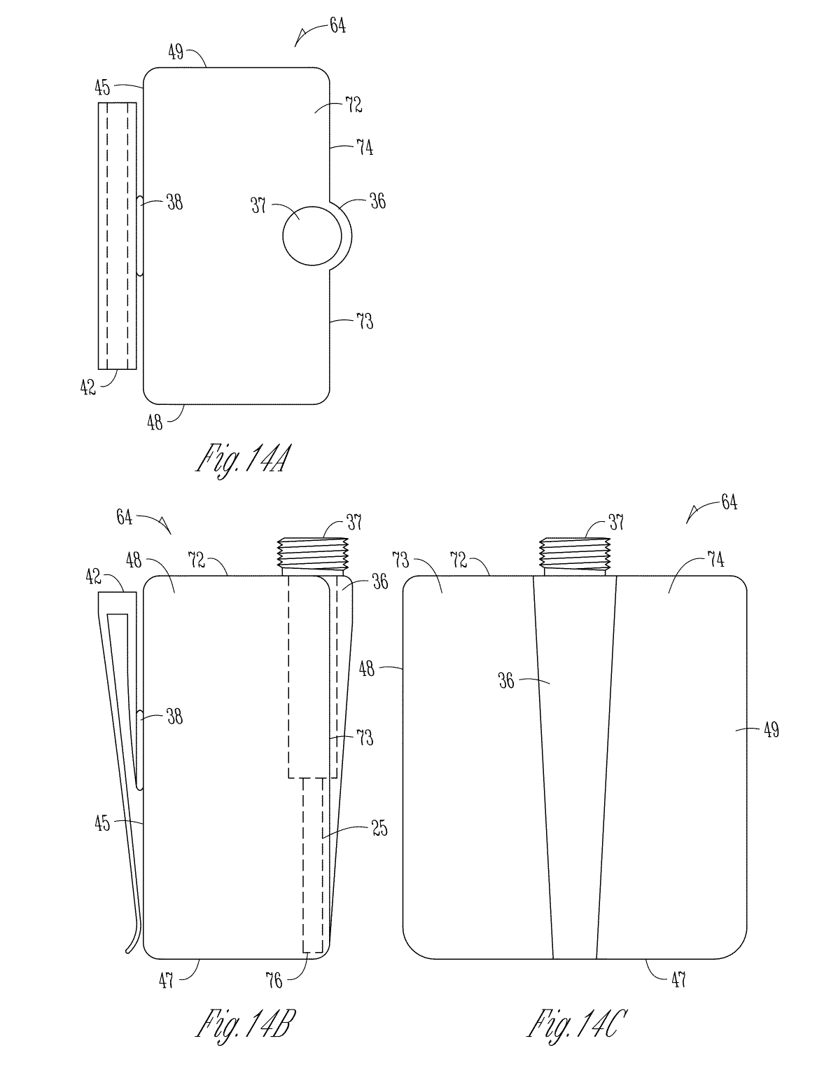

FIGS. 14A-C illustrate a dispenser body 64 which forms an inner cavity for containing liquid. The dispenser body 64 has a front side which is formed with a left portion 73, a right portion 74 and a protruding side 36 and a rear side 45 which are generally wider than a left side 48 and a right side 49. The left side 48 and the right side 49 are generally parallel to each other. A top side 72 and a bottom side 47 are generally parallel to each other. The corners are generally rounded. The top side 72 has a mounting opening 37 for the pump assembly 10 which is offset within the protruding portion 36. The opening 37 remains centered between the left and right sides 48 and 49. A removable pump assembly may be attached into opening 37. A mounting attachment 38 allows for a clip 42 to be easily attached and removed to the dispenser body 64. The protruding portion 37 positions the inlet 76 of the dip extension 25 of the pump assembly towards the lower part of the dispenser body 64 to maximize the amount of product the liquid dispenser can deliver between refills when attached to a sun visor of a vehicle or door panel or other location.

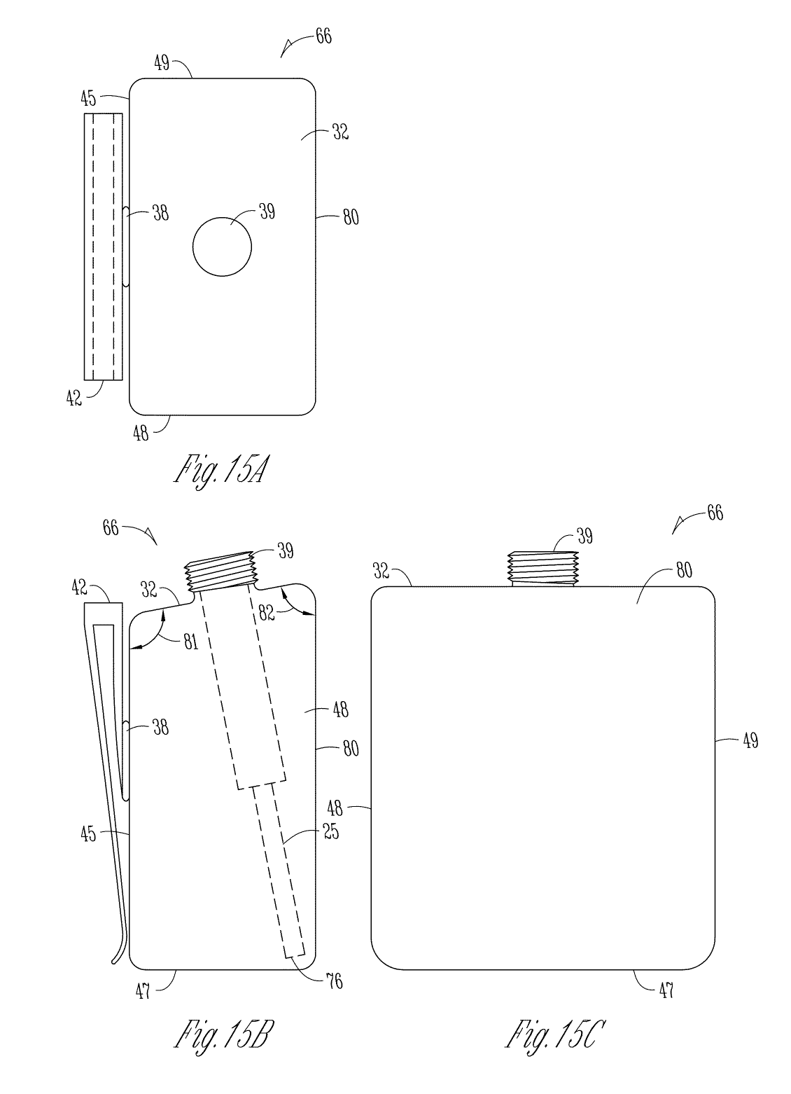

FIGS. 15A-C illustrate a dispenser body 66 which forms an inner cavity for containing liquid. The corners are generally rounded. The dispenser body 66 has a front side 80 and a rear side 45 which are generally wider than a left side 48 and a right side 49. The front side 80 and the rear side 45 are generally parallel to each other. The left side 48 and the right side 49 are generally parallel to each other. The top side 32 has a mounting opening 39 for the pump assembly which is generally centered front to rear and left to right. The top side 32 is not parallel to bottom side 47. The angle 81 formed by a surface on the top side 32 and a surface on the rear side 45 is obtuse. The angle 82 formed by a surface of the front side 80 and a surface of the top side 32 is acute. A mounting attachment 38 allows for a clip 42 to be easily attached and removed to the dispenser body 66. The angled opening 39 positions the inlet 76 of the dip extension 25 of the pump assembly towards the lower part of dispenser body 66 where the front side 80 and the bottom side 47 converge to maximize the amount of the product the liquid dispenser can deliver between refills when attached to a sun visor of a vehicle or door panel or other location.

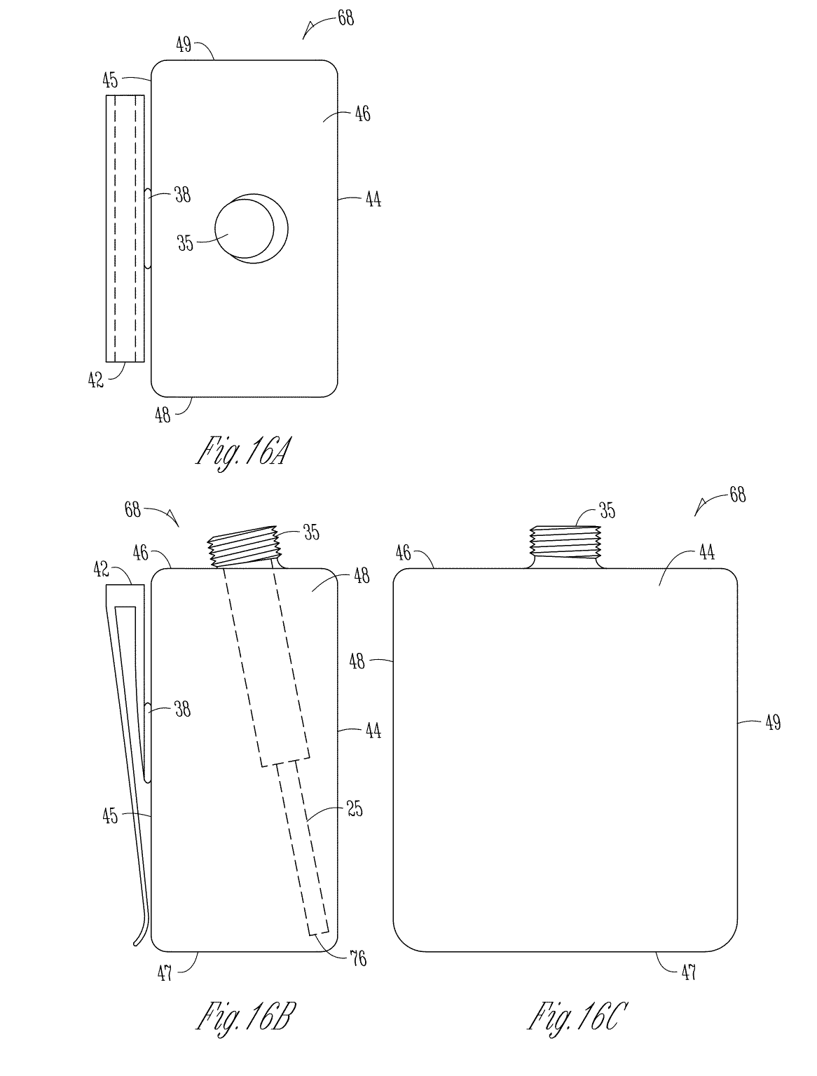

FIGS. 16A-C illustrate a dispenser body 68 which forms an inner cavity for containing liquid. The dispenser body 68 has a front side 44 and a rear side 45 which are generally wider than left side 48 and right side 49. Front side 44 and rear side 45 are generally parallel to each other. Left side 48 and right side 49 are generally parallel to each other. A top side 46 and bottom side 47 are generally parallel to each other. The corners are generally rounded. Top side 46 has an angled mounting aperture 35. The mounting aperture 35 is centered on the top side 46. A removable pump assembly may be attached into the opening 35. A mounting attachment 38 allows for a clip 42 to be easily attached and removed to the dispenser body 68. The mounting aperture 35 positions the inlet 76 of the dip extension 25 of the pump assembly towards the lower part of dispenser body 68 where the front side 44 and the bottom side 47 converge to maximize the amount of product the liquid dispenser 28 can deliver between refills when attached to a sun visor of a vehicle or door panel or other location.

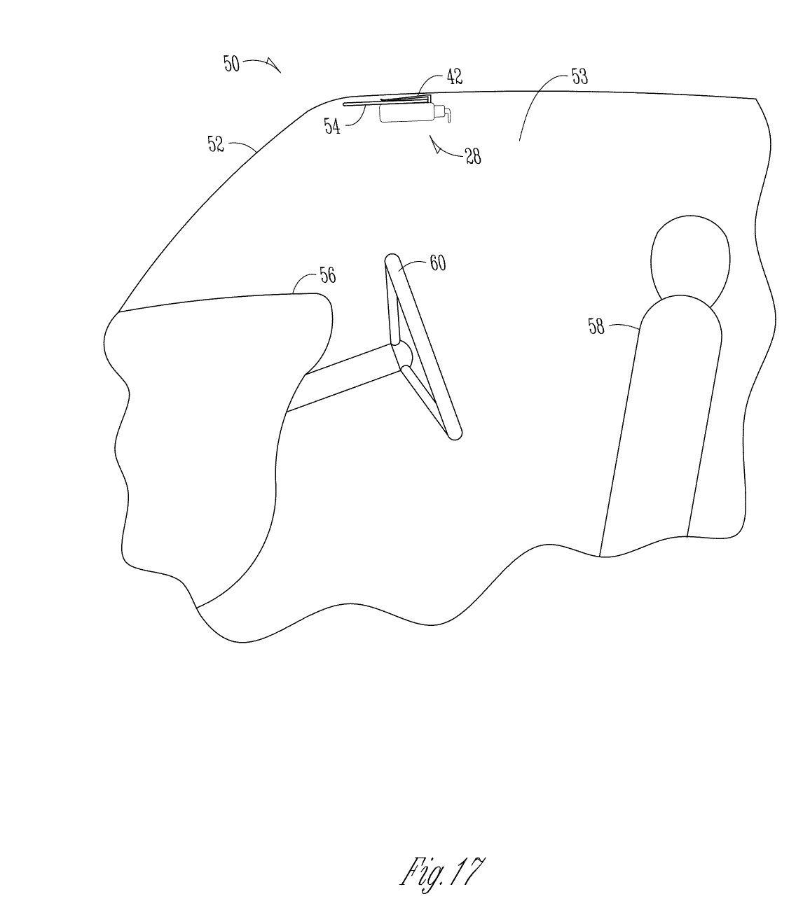

FIG. 17 illustrates the liquid dispenser attached to a vehicle cabin sun visor. The vehicle cabin generally has a seat 58, a steering wheel 60 and a dash 56. The liquid dispenser 28 is attached to a driver or passenger sun visor 54 via clip 42 within the vehicle cabin 50. Either position will result in the dispenser 28 being within a safe reaching distance of the driver and/or the passenger

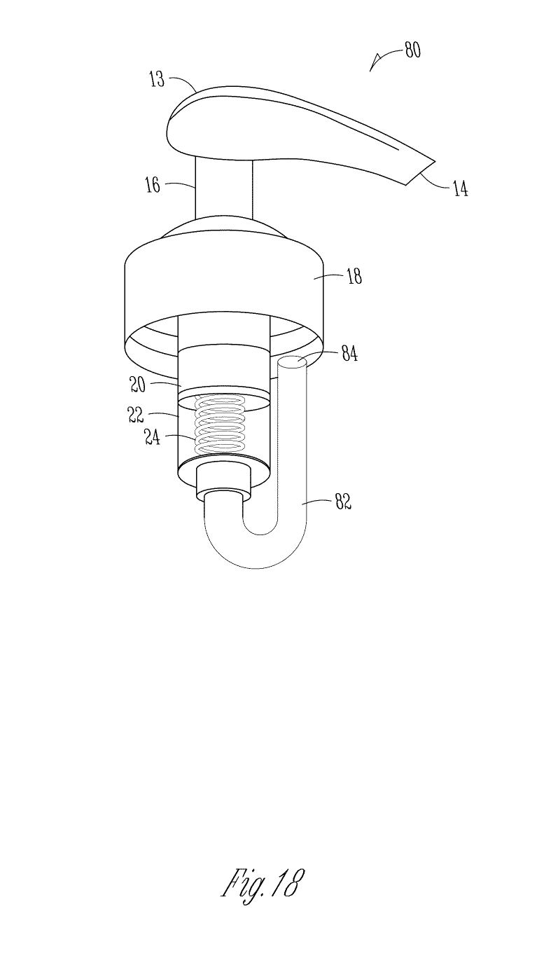

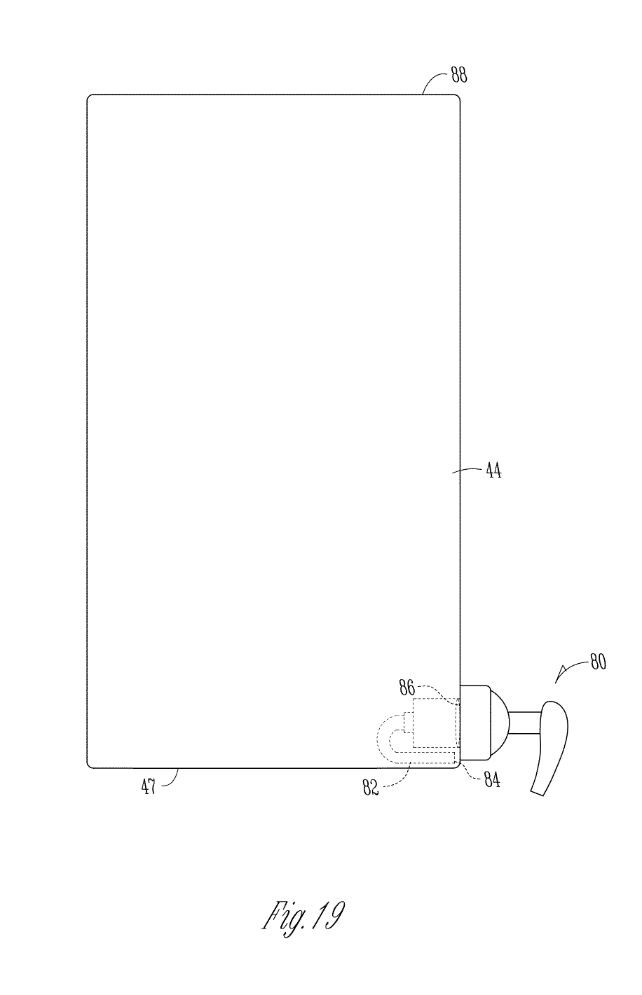

FIG. 18 is a perspective view of another embodiment of a push pump. In FIG. 18, the push pump 80 has a u-shaped dip extension 82 with an inlet 84. Note that the u-shaped dip extension 82 extends downwardly from the spring 24 and then U-turns back upwardly towards the threaded cap member 18. The push pump 80 may be used where the push pump is mounted at a bottom of a dispenser body. FIG. 19 illustrates a liquid dispenser with an aperture 86 along the front side 44 and near the bottom side 47 of the dispenser body 88. The push pump 80 of FIG. 18 may be used in this embodiment. Thus, the inlet 84 of the dip extension is positioned within the inner cavity at a junction of a front side 44 of the body and a bottom side 47 of the body to access fluid within the inner cavity even when the fluid is nearly depleted from the inner cavity.

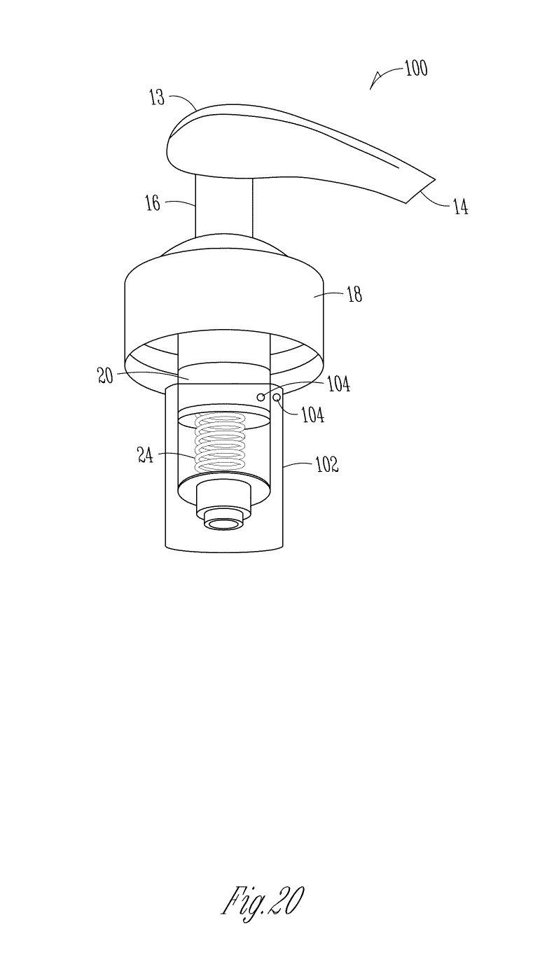

FIG. 20 illustrates another embodiment of a push pump. The push pump 100 does not have a dip extension as in certain other embodiments. Instead there are one or more inlets 104 through which a liquid product may be received into the pump housing 102 and then ultimately dispensed through the outlet 14.

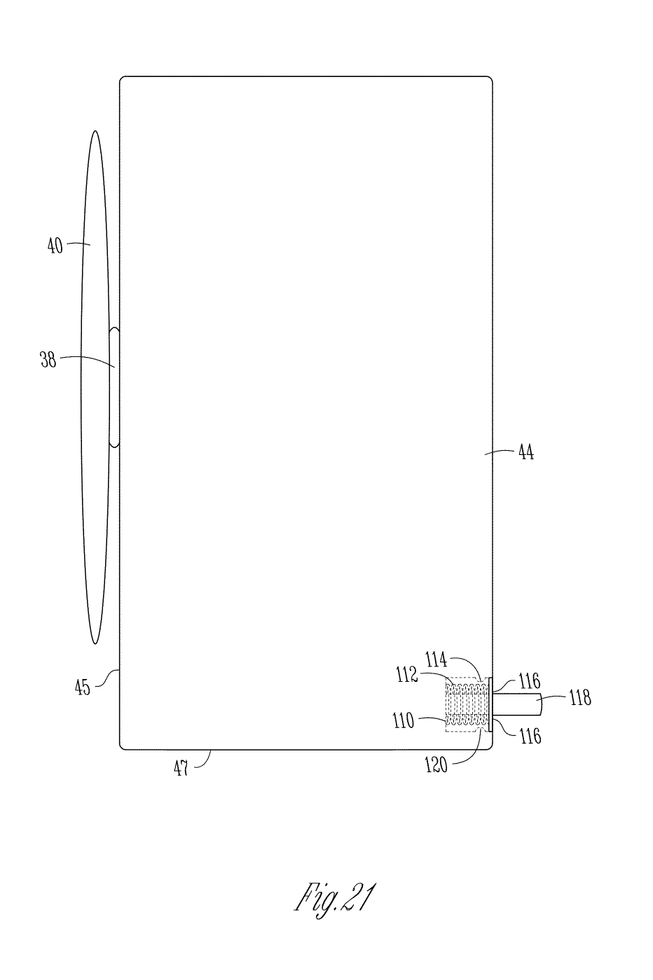

FIG. 21 illustrates an embodiment where the pump is located at a bottom of the liquid dispenser. A pump housing 110 is shown. A spring 112 is shown which is used to return a pin 118. There are one or more inlets 114 for the product to enter the pump area once a user pushes the pin 118. There are also one or more openings 116 through which the product may discharge. A push pump plate 120 is attached to the pin 118. When a user presses or pushes the pin 118 and the plate 120 inwardly, the product to be dispensed is loaded into the pump. The spring 112 then returns the pin 118 and the plate 120 back out thereby expelling the product through the discharge openings 116.

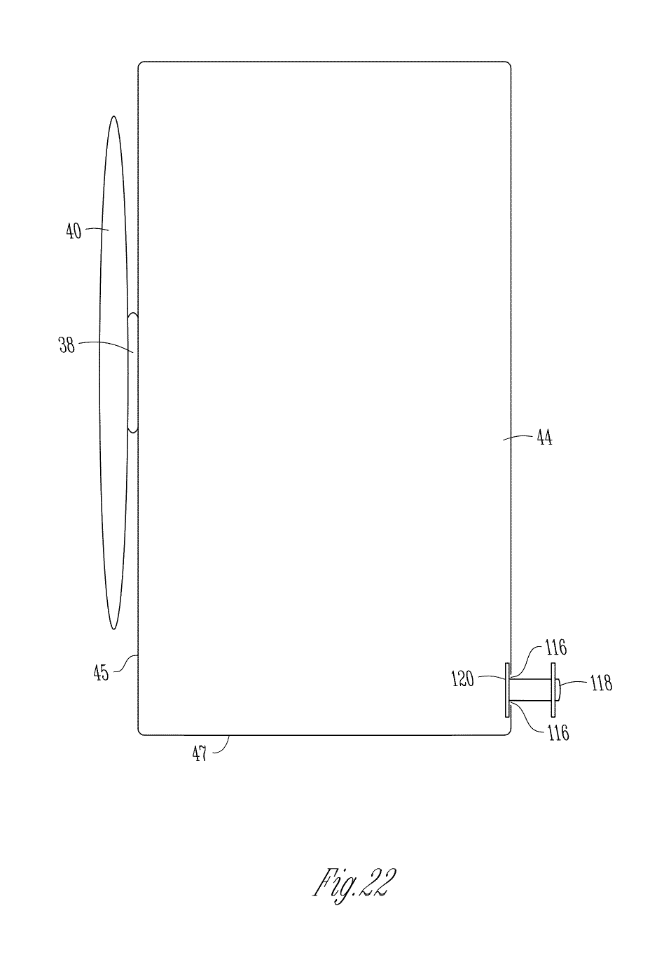

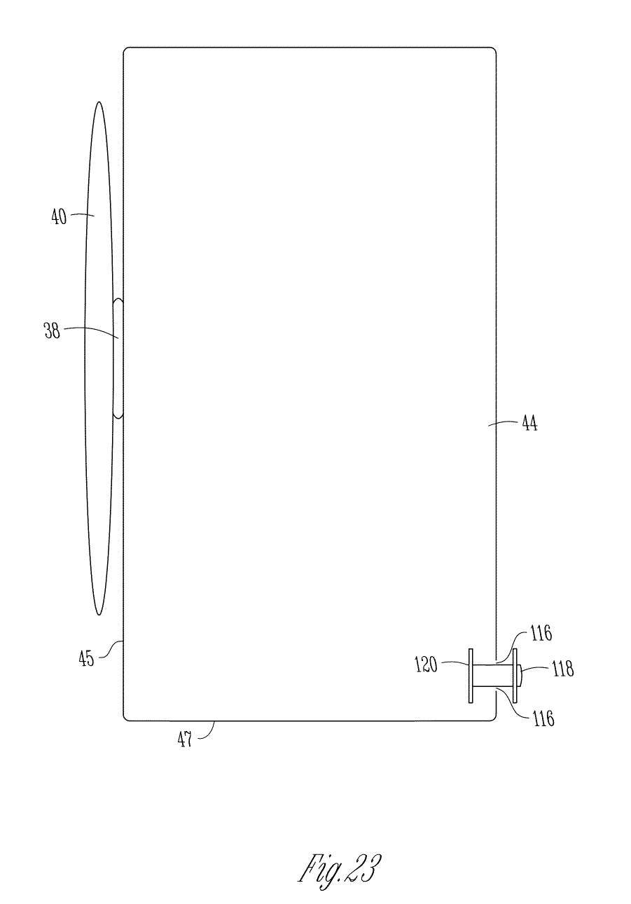

FIG. 22 illustrates another embodiment of a liquid dispenser where the push pump would be located at the bottom of the liquid dispenser and a push pin is in an extended position. In the embodiment shown, a threaded aperture in the liquid dispenser body could still be used. In addition, the function of the dip extension is integrated into the pump assembly to maximize the low mounting point of the pump. Note that FIG. 22, like the embodiment shown in FIG. 19 provides for mounting a discharge system on the front or sides of the dispenser body. FIG. 22 illustrates a gravity closed push pin position with no product discharging. The pin 118 is attached to a push plate 120. FIG. 23 illustrates the liquid dispenser of FIG. 22 except that the push pin is in a retracted position. In operation, a user pushes the pin 118 to move the pin 118 and the plate 120 inwardly to start dispensing product from the opening(s) 116.

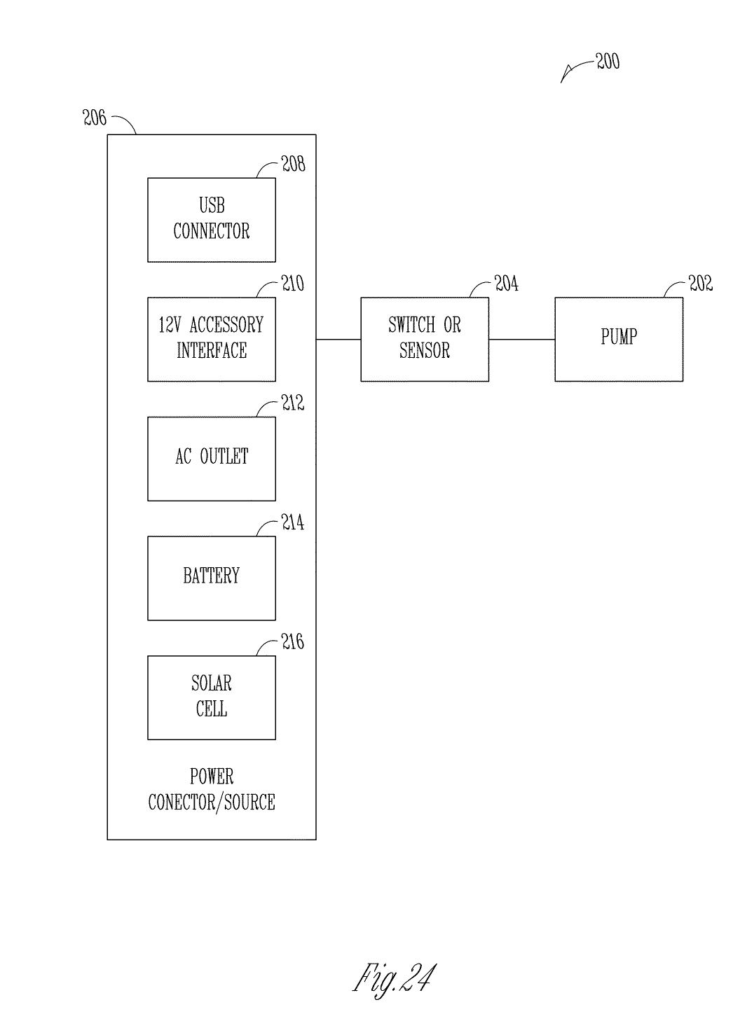

FIG. 24 illustrates another embodiment where the liquid dispenser may provide for automatic or handsfree dispensing. Where automatic or handsfree dispensing is used, an electric pump 202 may be powered with electrical energy. One or more switches or sensors 204 may be used to turn on and off the electric pump 202. Various types of switches or sensors may be used including motion sensors, infrared sensors, capacitive sensors, or switches or sensors using other types of sensing technology. Electrical energy is provided using a power connector or other energy source 206. Various types of power connectors or sources 206 may be used including a USB connector 208, a 12V vehicle accessory interface 210, an AC outlet 212, a battery 214, and a solar cell 216. It is to be contemplated that depending upon the type of power source appropriate additional electronics or circuitry may be included to provide for signal conditioning and/or power conversion as well as electrical safety. In addition, multiple interfaces or connectors may be provided such as both a solar cell 216 and a battery 214. In addition, although the switch or sensor 204 is shown directly connected to the pump 202, it is to be understood that additional circuitry may be present such as additional relays or switches, or other circuitry depending upon the electrical source 206 and the electrical requirements of the electric pump 202. Also, an intelligent control such as a microcontroller may also be used where additional complexity is required such as to time the dispensement, to vary the dispensing time, or to otherwise provide additional functionality. It should also be understood that where an electric pump is used the liquid dispenser may otherwise appear the same or similar to those shown and described.

The liquid dispenser can also be packaged with one or more sets of removable mounts such as suction cups to mount the liquid dispenser to various locations. Alternatively the liquid dispenser may have a permanent mount. The liquid dispenser is preferably comprised of a dishwasher safe material to aid in cleaning and sanitizing between uses. Alternatively, the liquid dispenser may be disposable.

Therefore an improved liquid dispenser has been provided. It should be understood that the liquid dispenser is configured for use in various environments especially within a vehicle, on surfaces that tilt forward, upper/top mountings, or elsewhere that is not conducive to having the liquid dispenser sit on a flat surface. The present invention contemplates numerous variations in materials used, configurations, shapes, sizes, and other variations within the scope of the invention now claimed.

What is claimed is:

1. A liquid dispenser, comprising:
a body having an inner cavity for containing liquid, and an opening providing access to the inner cavity;
a pump removably fitted with the aperture with a dip extension extending downwardly into the inner cavity, the dip extension having an inlet;
wherein the inlet of the dip extension is positioned within the inner cavity at a junction of a front side of the body and a bottom side of the body to thereby access fluid within the inner cavity when the fluid is nearly depleted from the inner cavity.

2. The liquid dispenser of claim 1 further comprising a mount operatively connected to the body thereby configuring the liquid dispenser for mounting within a vehicle.

3. The liquid dispenser of claim 2 wherein the mount comprises a clip.

4. The liquid dispenser of claim 3 wherein the clip is a sun visor clip.

5. The liquid dispenser of claim 2 wherein the mount comprises at least one suction cup.

6. The liquid dispenser of claim 1 wherein the opening is offset forwardly from a center point between the opposite front and back sides of the body.

7. The liquid dispenser of claim 1 wherein the opening is positioned centrally relative to opposite left and right sides of the body.

8. The liquid dispenser of claim 2 wherein the opening is positioned centrally relative to opposite front and back sides of the body.

9. The liquid dispenser of claim 8 wherein the dip extension extends downwardly and then angularly towards the junction of a front side of the body and the bottom side of the body.

10. The liquid dispenser of claim 1 wherein the dip extension is flexible such that the inlet of the dip extension is positioned at the junction of the front side of the body and the bottom side of the body.

11. The liquid dispenser of claim 8 wherein an angle of the top side of the body relative to the front side of the body is less than 90 degrees and wherein an angle of the top side of the body relative to the back side of the body is greater than 90 degrees.

12. The liquid dispenser of claim 11 wherein the dip extension generally straight and is directed downwardly from the opening towards the junction of a front side of the body and the bottom side of the body.

13. The liquid dispenser of claim 2 wherein the opening is positioned towards the back side relative to opposite front and back sides of the body.

14. The liquid dispenser of claim 2 wherein the opening is offset forwardly from a center point between the opposite front and back sides of the body.

15. The liquid dispenser of claim 14 wherein the dip extension extends downwardly and then angularly towards the junction of a front side of the body and the bottom side of the body.

16. The liquid dispenser of claim 2 wherein the top side includes a central protruding portion and wherein the opening is positioned at least partially within the central protruding portion.

17. The liquid dispenser of claim 16 wherein the central protruding portion extends downwardly from the top side along the front side.

18. The liquid dispenser of claim 1 wherein the body comprises a neck extending upwardly from the top side with the opening in the neck.

19. The liquid dispenser of claim 1 further comprising sanitizing or disinfecting liquid within the body.

20. The liquid dispenser of claim 1 further comprising lotion within the body.

21. The liquid dispenser of claim 1 wherein the opening is positioned on the front side of the body and proximate a bottom side of the body.

22. The liquid dispenser of claim 1 wherein the pump is a push pump.

23. The liquid dispenser of claim 1 wherein the pump is an electric pump.

24. A method of using a liquid dispenser, comprising:
providing the liquid dispenser, the liquid dispenser comprising a body having an inner cavity for containing liquid, and an opening providing access to the inner cavity, a pump removably fitted with the aperture with a dip extension extending downwardly into the inner cavity, the dip extension having an inlet, and wherein the inlet of the dip extension is positioned within the inner cavity at a junction of a front side of the body and a bottom side of the body to thereby access fluid within the inner cavity when the fluid is nearly depleted from the inner cavity;
mounting the liquid dispenser within a vehicle such that the bottom side of the dispenser body is positioned such that a lowest point within the inner cavity is at the front and the bottom of the liquid dispenser.

25. The method of claim 24 wherein the mounting comprises clipping a clip on the liquid dispenser to a sun visor on the vehicle.

26. The method of claim 24 wherein the mounting comprises mounting a suction cup on the liquid dispenser to a window on the vehicle.

27. The method of claim 24 wherein the pump is a push pump.

28. The method of claim 24 wherein the pump is an electric pump.

29. The method of claim 24 wherein the mounting comprises mounting the liquid dispenser to a front windshield on the vehicle.
